(19) United States
(12) Patent Application Publication
(10) Pub. No.: US 2010/0223805 A1
(43) Pub. Date: Sep. 9, 2010

(54) SUBSTRATE PROCESSING DEVICE, RECYCLING METHOD OF FILTRATION MATERIAL AND RECORDING MEDIUM

(75) Inventors: Hironobu HYAKUTAKE, Koshi City (JP); Hideki NISHIMURA, Koshi City (JP); Hiroshi TANAKA, Koshi City (JP)

Correspondence Address: CANTOR COLBURN, LLP, 20 Church Street, 22nd Floor, Hartford, CT, 06103, US

(73) Assignee: TOKYO ELECTRON LIMITED, Tokyo (JP)

(21) Appl. No.: 12/718,008

(22) Filed: Mar. 5, 2010

(30) Foreign Application Priority Data
Mar. 6, 2009 (JP) 2009-053925

(51) Int. Cl. F26B 21/06

(52) U.S. Cl. 34/427; 34/82

(57) ABSTRACT

Disclosed is a substrate processing device, in which for a filtration material to remove particles contained in a gas used for a drying process, the accretion attached on the filtration material can be removed in a state where the filtration material is disposed on a flow path through which gas flows. The disclosed substrate processing device performs a drying process on a substrate by generating a drying gas from a drying gas generating unit, removing particles in the drying gas by having the drying gas flow through a filtration material, and contacting the gas with the substrate with a liquid remaining thereon in a processing unit. A filtration material heating part heats the filtration material up to a first temperature during the drying process in order to maintain the drying gas at a temperature higher than a dew point temperature of the drying gas, and heats the filtration material up to a second temperature higher than the first temperature during a recycling process of the filtration material in order to evaporate and remove accretion attached on the filtration material.

This application is based on and claims priority from Japanese Patent Application No. 2009-053925, filed on Mar. 6, 2009, with the Japanese Patent Office, the disclosure of which is incorporated herein in its entirety by reference.

### TECHNICAL FIELD

The present disclosure relates to a substrate processing device and a recycling method of a filtration material used for the device. The substrate processing device performs a drying process on a substrate with a liquid remaining thereon by contacting a drying gas containing an organic material with the substrate.

### BACKGROUND

In a treatment process for a substrate, such as a semiconductor wafer for a semiconductor device, or a glass substrate for a flat panel display, there has been widely used a cleaning process for cleaning the substrate as a target object by sequentially immersing it in a processing bath storing a liquid such as a chemical liquid or a rinsing liquid (cleaning liquid). Also, after the cleaning process, a drying process for removing the liquid remaining on the surface of the substrate is performed, in which a drying gas containing a volatile organic material, such as an organic solvent (e.g., isopropyl alcohol (IPA) with a boiling point of 82.4° C.), is heated up to approximately 180° C. to 200° C., and then is sprayed on the substrate taken out from the cleaning liquid. This drying process prevents the occurrence of watermarks.

As disclosed in paragraph [0020] and FIG. 1 of Japanese Patent Laid-open Publication No. 2003-75067, before the drying gas is supplied to the substrate, contaminants (such as particles) contained in the gas are removed by a filter or the like in order to prevent the substrate from being re-polluted. When a gas flowing through the filter is heated up to a high temperature approximately 190° C. as described above, a heat resistant filter, such as a metallic filter made of a porous filtration material (e.g., sintered metal) and a ceramic filter, is employed.

The above described IPA-containing drying gas may be obtained by heating or evaporating a misty IPA sprayed in the nitrogen atmosphere. However, in some cases, IPA as a raw material liquid may contain a very small amount of impurities, such as an organic material having a boiling point higher than that of IPA (hereinafter, referred to as a high-boiling point organic material). Such impurities together with IPA are evaporated and flown to the downstream side, while some of the impurities are trapped as accretion on, for example, a metallic filter, by being absorbed inside the pores. Also, in some cases, it is known that an organic material attached on a pipe system for generating and supplying the drying gas is vaporized in the drying gas, flown to the metallic filter, and trapped as accretion on the metallic filter.

When a high-boiling point organic material is trapped by the metallic filter as described above, the accumulated amount of the organic material increases and then readily reaches a saturation state. Then, the trapped accretion starts to be splintered off to the downstream side and pollutes a substrate. Especially, as a semiconductor device has recently been highly integrated up to a nanometer level, the pollution by the remnants of the organic material becomes a primary factor of lowering the performance of the semiconductor device. For this reason, conventionally, it has been assumed that when the high-boiling point organic material starts to be splintered off, the life span of the metallic filter used for the drying process comes to an end. Thus, maintenance has been performed by replacing the metallic filter with a new one before the life span comes to an end.

However, such maintenance requires stopping the entire apparatus for cleaning treatment, and dismantling and re-assembling the system for supplying the drying gas, and thereby becomes one of the factors of lowering the operating rate of an apparatus. In addition, in some cases, although a metallic filter still has a sufficient capability of collecting the particles, the metallic filter has to be replaced with a new one because the life span of the metallic filter provided for removing particles is determined based on the timing that the high-boiling point organic material starts to be splintered off. This early replacement of the metallic filter is inefficient.

Meanwhile, paragraphs [0051], [0055] to [0057], and FIG. 1 of Japanese Patent Laid-open Publication No. 2007-234862 disclose an apparatus for performing surface treatment of a substrate, such as a cleaning process, a resist stripping process, and a drying process, by using a high-pressure fluid such as a supercritical fluid. In this technology, a filter is provided in a pipe path for supply of the high-pressure fluid so as to remove particles contained in the high-pressure fluid, while as required, the high-pressure fluid is flown backward so as to backwash particles accumulated in the supply side of the high-pressure fluid and discharge them to the outside of the apparatus. However, the above Japanese Patent Laid-open Publication does not consider an attachment of a high-boiling point organic material contained in the gas on a filter, and a splintering of the organic material.

### SUMMARY

According to one embodiment, there is provided a substrate processing device to perform a drying process on a substrate by a drying gas. The substrate processing device includes a drying gas generating unit to generate the drying gas by heating a fluid and have a temperature adjustment function, a filtration material to remove particles contained in the drying gas generated by the drying gas generating unit, a filtration material heating part to heat the filtration material, a processing unit to perform the drying process by using the drying gas having passed through the filtration material, and a control unit to control the filtration material heating part in such a manner that the filtration material heating part heats the filtration material up to a first temperature during the drying process in order to maintain the drying gas supplied to the processing unit at a temperature higher than a dew point temperature of the drying gas, and heats the filtration material up to a second temperature higher than the first temperature during a recycling process of the filtration material in order to evaporate and remove accretion attached on the filtration material.

The foregoing summary is illustrative only and is not intended to be in any way limiting. In addition to the embodiment and features described above, further aspects, embodiments, and features will become apparent by reference to the drawings and the following detailed description.

### BRIEF DESCRIPTION OF THE DRAWINGS

FIG. 1 is a cross sectional plan view illustrating a wafer cleaning apparatus according to an embodiment.

FIG. 2 is a vertical sectional side view illustrating the internal configuration of the wafer cleaning apparatus.

FIG. 3 is a partially cutaway perspective view illustrating the internal configuration of a processing unit provided in the wafer cleaning apparatus.

FIG. 4 is a vertical sectional side view illustrating the configuration of a cleaning/drying unit provided in the processing unit.

FIG. 5 is an explanatory view illustrating the configuration of an IPA vapor generating unit provided in the processing unit.

FIG. 6 is a vertical sectional side view illustrating the configuration of a filter unit provided in the IPA vapor generating unit.

FIGS. 7A and 7B are an explanatory view illustrating the operations of the IPA vapor generating unit and the filter unit.

FIGS. 8A, 8B, and 8C are an explanatory view illustrating the experiment results according to Examples and a Reference Example.

### DETAILED DESCRIPTION

In the following detailed description, reference is made to the accompanying drawings, which form a part hereof. The illustrative embodiments described in the detailed description, drawings, and claims are not meant to be limiting. Other embodiments may be utilized, and other changes may be made, without departing from the spirit or scope of the subject matter presented here.

The present disclosure provides a substrate processing device, a recycling method of a filtration material provided in the device, and a recording medium recording a computer program for executing the recycling method. In the substrate processing device, a accretion attached on a filtration material that removes particles in a gas used for a drying process can be removed in a state where the filtration material is disposed on a flow path through which the gas flows.

According to one embodiment, there is provided a substrate processing device to perform a drying process on a substrate by a drying gas. The substrate processing device includes a drying gas generating unit to generate the drying gas by heating a fluid and have a temperature adjustment function, a filtration material to remove particles contained in the drying gas generated by the drying gas generating unit, a filtration material heating part to heat the filtration material, a processing unit to perform the drying process by using the drying gas having passed through the filtration material, and a control unit to control the filtration material heating part in such a manner that the filtration material heating part heats the filtration material up to a first temperature during the drying process in order to maintain the drying gas supplied to the processing unit at a temperature higher than a dew point temperature of the drying gas, and heats the filtration material up to a second temperature higher than the first temperature during a recycling process of the filtration material in order to evaporate and remove accretion attached on the filtration material.

The filtration material may be made of a metallic material or a ceramic material.

The filtration material may be received in a filtration material receiving portion, the filtration material heating part may include a heater to heat the filtration material receiving portion, and the control unit may control an amount of heat generated by the heater during the recycling process of the filtration material to be higher than an amount of heat generated by the heater during the drying process.

The substrate processing device may further include a purging gas supply unit to supply a purging gas to the filtration material in order to discharge an evaporated substance of the accretion attached on the filtration material during the recycling process of the filtration material.

The purging gas supply unit may have a temperature adjustment function in order to perform as the filtration material heating part to heat the filtration material by the purging gas.

The temperature adjustment function of the purging gas supply unit includes the temperature adjustment function of the drying gas generating unit.

The substrate processing device may further include an exhaust path formed between the filtration material and the processing unit, and a flow path switching part to switch a flow path of a gas having passed through the filtration material between a processing unit side and an exhaust path side, wherein the control unit switches a flowing direction of the purging gas having passed through the filtration material toward the exhaust path side during the recycling process of the filtration material.

The drying gas may be a mixed gas of vapor of an organic solvent and inert gas.

The organic solvent may be isopropyl alcohol.

According to the present disclosure, during a drying process of a substrate, a filtration material for removing particles contained in a drying gas used for the drying process is heated up to a first temperature higher than a dew point temperature of the drying gas, and during a recycling process of the filtration material, the filtration material is heated up to a second temperature higher than the first temperature. Thus, the accretion attached on the filtration material can be evaporated and removed in a state where the filtration material is disposed on a flow path through which gas flows. As a result, there is no need to dismantle or re-assemble a supply system of a drying gas to replace a metallic filter with a new one, and thereby it is possible to improve the operating rate of the device by reducing the stop period of it.

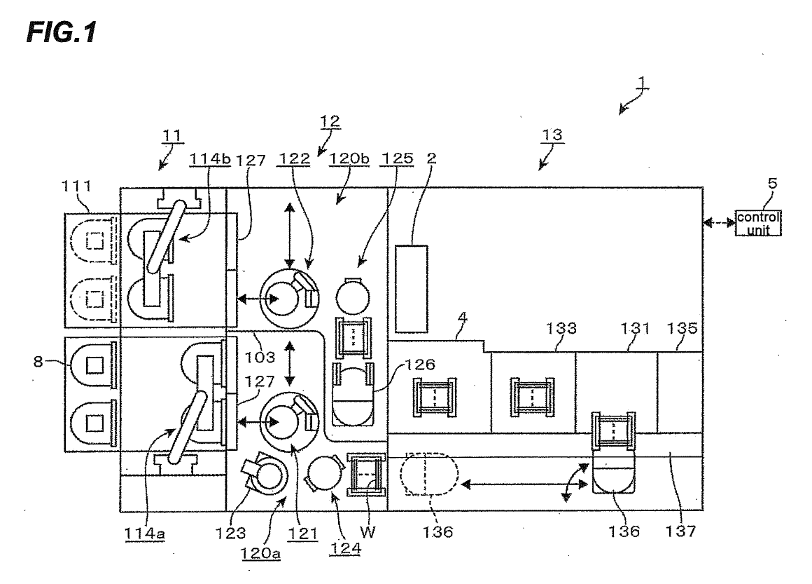

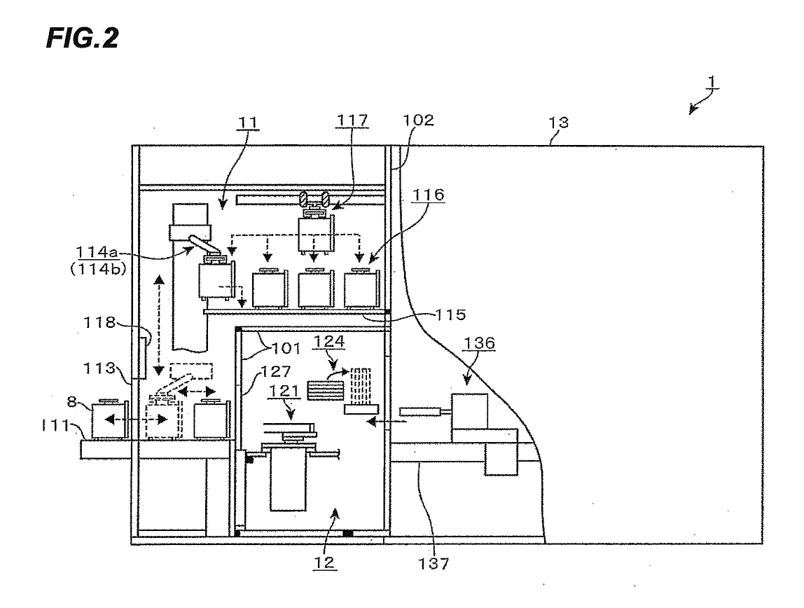

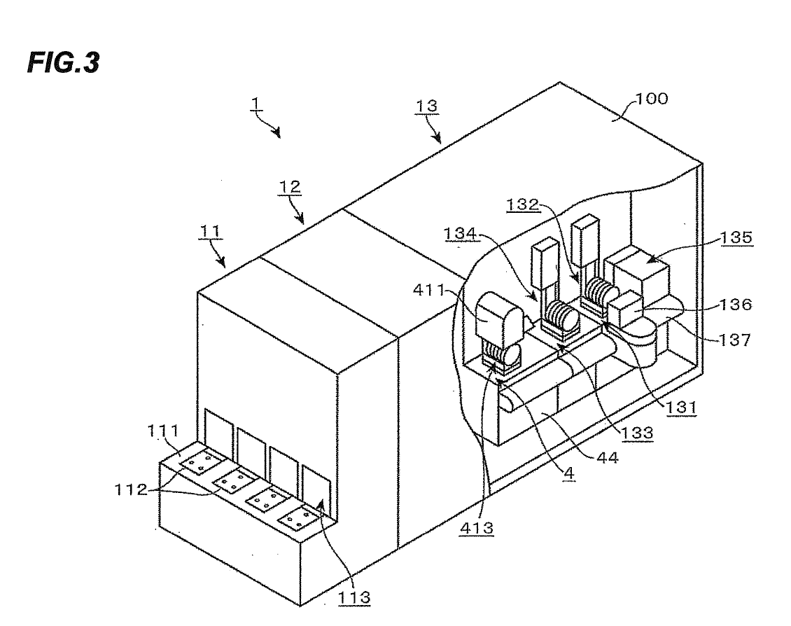

Hereinafter, an embodiment applying a substrate processing device according to the present disclosure to a batch type wafer cleaning apparatus will be described. FIG. 1 is a plan view illustrating a wafer cleaning apparatus 1 according to the present embodiment, FIG. 2 is a vertical sectional side view of wafer cleaning apparatus 1, and FIG. 3 is a perspective view of wafer cleaning apparatus 1. In these drawings, when the left side is referred to as a front area, wafer cleaning apparatus 1 includes a loading/unloading device 11, an interface device 12, and a processing unit 13, which are provided within a case 100 in this order from the front area. Loading/unloading device 11 is to load/unload a FOUP 8. Interface device 12 is to adjust the position of wafers W or alter the posture of wafers W while wafers W are transferred between FOUP 8 loaded into loading/unloading device 11 and processing unit 13 at the rear area. Processing unit 13 is to perform a liquid processing and a drying process on wafers W.

In a case where FOUP 8 storing a plurality of wafers W is carried by a carrying robot, called OHT (Overhead Hoist Transport), traveling along a carrying path disposed at the ceiling in a factory provided with wafer cleaning apparatus 1, loading/unloading device 11 performs a role of transferring FOUP 8 between the OHT (not shown) and wafer cleaning apparatus 1, and keeping FOUP 8 in an empty state after unloading of wafers W during the processing on wafers W.

Loading/unloading device 11 includes a load port 111, first lifters 114a and 114b, and a keeping area 116. Load port 111 is to transfer FOUP 8 to/from the OHT. First lifters 114a and 114b are provided within loading/unloading device 11, and carry FOUP 8 loaded into loading/unloading device 11. Keeping area 116 is to keep FOUP 8 in an empty state after unloading of wafers W.

Load port 111 is provided at the front area of wafer cleaning apparatus 1, and is configured as a disposition table, which can dispose, for example, 4 FOUPs 8, in a line along a width direction. As shown in FIG. 3, in a disposition area of each of FOUPs 8, a disposition table 112 is provided in such a manner that it can slide in forward/backward direction, and can move FOUP 8 disposed on load port 111 between load port 111 side and the inside of loading/unloading device 11 via an opening 113 opened at the front area of wafer cleaning apparatus 1. In the present embodiment, load port 111 provided with two disposition tables 112 at the right side from the perspective of the front area of loading/unloading device 11 is used to load FOUP 8 into loading/unloading device 11, and load port 111 provided with two disposition tables 112 at the left side is used to unload FOUP 8 from loading/unloading device 11. Also, the reference numeral 118 noted in FIG. 2 denotes an open/close door for opening/closing each opening 113.

At both (left and right) sides within loading/unloading device 11, first lifters 114a and 114b which are configured to move in upward/downward and forward/backward directions are provided. First lifters 114a and 114b perform a role of carrying FOUP 8 between a position on disposition table 112 slid into loading/unloading device 11, an access position to interface device 12 at the rear area, and keeping area 116 for keeping empty FOUP 8. As shown in FIGS. 1 and 2, first lifters 114a and 114b according to the present embodiment can hold top flanges of two FOUPs 8 at once and then carry them. In the present embodiment, two FOUPs 8 loaded from load port 111 at the left side from the perspective of the front area is carried by first lifter 114a provided in the lateral wall at the left side, and two FOUPs 8 loaded from load port 111 at the right side is carried by first lifter 114b provided in the lateral wall at the right side.

As shown in FIG. 2, the upper side space of loading/unloading device 11 extends inward to above interface device 12 provided at the rear end of loading/unloading device 11, and includes keeping area 116 for keeping FOUP 8 in an empty state after unloading of wafers W. At the bottom portion of keeping area 116, a supporting table 115 capable of disposing a total of 16 FOUPs 8, for example, 4 columns in forward/backward directions, and 4 rows in left/right directions is provided. At the ceiling side of keeping area 116, a second lifter 117 is provided. Second lifter 117 can move a holding portion for holding the top flange of FOUP 8 in upward/downward, forward/backward, and left/right directions. Second lifter 117 can move FOUP 8, which is, for example, carried to the foremost column of supporting table 115 by the above described first lifters 114a and 114b, to any disposition position on supporting table 115. Herein, FOUP 8 storing wafers W can be disposed in keeping area 116.

As shown in FIGS. 1 and 2, interface device 12 is a space formed by partitioning the inside of case 100 of wafer cleaning apparatus 1 from loading/unloading device 11 and processing unit 13 by partition walls 101 and 102, as front and rear walls and an upper wall. The space within interface device 12 is further partitioned into two spaces by a partition wall 103, thereby forming first and second interface chambers 120a and 120b. First interface chamber 120a is a space for carrying wafers W to be treated toward processing unit 13, within which a wafer taking-out arm 121, a notch aligner 123, and a first posture altering part 124 are provided.

Wafer taking-out arm 121 performs a role of drawing out wafers W from FOUP 8, and is configured to be movable in left/right directions from the perspective of the front area, and upward/downward directions, and rotatable. Notch aligner 123 supportedly rotates respective wafers W drawn out by wafer taking-out arm 121, on a plurality of plates, one by one, detects positions of notches provided in respective wafers W by a photo sensor or the like, and aligns the positions of notches between wafers W, thereby positioning wafers W.

First posture altering part 124 holds both opposite end portions at the circumferential side of respective wafers W positioned by notch aligner 123, and aligns and supports wafers W in a horizontal state in the up-and-down direction in a shelf form, and then adjusts the intervals among wafers W. Then, as shown in FIG. 2, first posture altering part 124 rotates wafers W aligned in a shelf form by 90° while holding both end portions of respective wafers W, and thereby alter the posture of respective wafers W into a vertical posture. FIG. 2 shows wafers W in a horizontal posture by a solid line, and wafers W in a vertical posture by a dotted line.

Meanwhile, second interface chamber 120b at the other side, formed by partition wall 103, is a space for carrying wafers W treated in processing unit 13 toward FOUP 8, and includes a transfer arm 126, a second posture altering part 125, and a wafer storing arm 122.

Transfer arm 126 performs a role of taking wafers W treated in processing unit 13 in a vertical state and carrying it. Second posture altering part 125, in opposite manner to that of above described first posture altering part 124, has a function of altering a vertical posture of wafers W into a horizontal posture. Also, wafer storing arm 122 is configured in the almost same manner as above described wafer taking-out arm 121, and performs a role of storing wafers W, whose posture has been altered into a horizontal posture by second posture altering part 125, into FOUP 8 in a stand-by mode at loading/unloading device 11 side.

Also, an open/close door 127 is provided on partition wall 101 between each of interface chambers 120a and 120b, and above described loading/unloading device 11. Open/close door 127 can detach a cover provided at the lateral surface of FOUP 8 disposed within loading/unloading device while facing open/close door 127, and can retreat the cover downward.

Processing unit 13 includes a first processing unit 131, a second processing unit 133, a cleaning/drying unit 4, a carrying arm 136, and a chuck cleaning unit 135. First processing unit 131 is to remove particles or organic pollutants remaining on wafers W carried from interface device 12. Second processing unit 133 is to remove metallic pollutants remaining on wafers W. Cleaning/drying unit 4 is to remove a chemical oxide film formed on wafers W and perform a drying process. Carrying arm 136 is to carry wafers W between these processing units 131, 133, and 4. Chuck cleaning unit 135 is to clean a wafer supporting chuck provided in carrying arm 136.

As shown in FIGS. 1 and 3, within processing unit 13, cleaning/drying unit 4, second processing unit 133, first processing unit 131, and chuck cleaning unit 135 are disposed in a straight line in this order from the front area. Carrying arm 136 is configured to be movable upward and downward and rotatable, and also can move forward and backward by being guided by a travel rail 137 formed along these units 4, 133, 131, and 135. Carrying arm 136 performs a role of carrying and transferring wafers W among respective processing units 4, 133, and 131, and interface device 12, and can carry, for example, 50 wafers W disposed in a vertical posture.

First and second processing units 131 and 133 are configured as processing baths, which can store a chemical, for example, an APM (Ammonium hydroxide-hydrogen Peroxide-Mixture) solution, an HPM (HCl-hydrogen Peroxide-Mixture) solution (mixed solution of hydrochloric acid, aqueous hydrogen peroxide, and deionized water), or the like. These processing units 131 and 133 include wafer boats 134 and 132 for transferring wafers W in a lump from/to carrying arm 136, and immersing these wafers W into a chemical liquid.

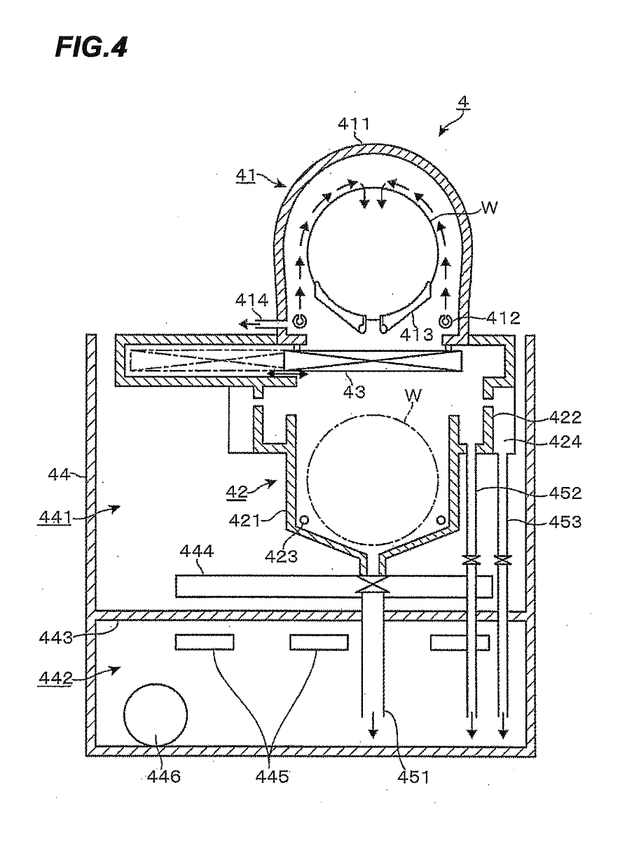

Meanwhile, cleaning/drying unit 4 can sequentially carry out two processes within one unit, in which the two processes include one process for removing a chemical oxide film formed on the surface of wafers W by a chemical, for example, hydrofluoric acid, and the other process for drying a liquid remaining on the surface of wafers W by using a drying gas (a mixed gas of IPA vapor and nitrogen gas). Cleaning/drying unit 4 has a different configuration from other two processing units 132 and 134, and thus will be described with reference to a vertical sectional side view shown in FIG. 4. FIG. 4 shows the vertical sectional side view of cleaning/drying unit 4 from the perspective of carrying arm 136 side.

Cleaning/drying unit 4 includes a cleaning bath 42, a drying chamber 41, a shutter 43, and a wafer boat 413. Cleaning bath 42 is to reservoir a chemical liquid such as hydrofluoric acid or a cleaning liquid such as deionized water. Drying chamber 41 is provided above cleaning bath 42 while communicating with the space within cleaning bath 42. Shutter 43 is configured to open/close a communication portion between drying chamber 41 and cleaning bath 42. Wafer boat 413 is to support a plurality of (e.g. 50) wafers W in such a manner that it can move these wafers W upward and downward between a space within cleaning bath 42 and a space within drying chamber 41.

Cleaning bath 42 is made of, for example, quartz, polypropylene, or the like, and includes an inner bath 421, an outer bath 422, an exhaust chamber 424, and a liquid supply nozzle 423. Inner bath 421 has an opened top portion. Outer bath 422 is disposed at the outer circumferential area of the upper portion of inner bath 421, and receives a cleaning liquid overflown from inner bath 421. Exhaust chamber 424 is disposed at the outer circumferential area of outer bath 422. Liquid supply nozzle 423 is provided at a lower portion within inner bath 421, at both (left/right) sides in FIG. 4, and spray a cleaning liquid or a chemical liquid, supplied from a chemical supply part (not shown), toward wafers W within inner bath 421. In the drawing, the reference numeral 451 denotes a first drainage path formed in the bottom portion of inner bath 421, the reference numeral 452 denotes a second drainage path formed in the bottom portion of outer bath 422, and the reference numeral 453 denotes an exhaust path formed in the bottom portion of exhaust chamber 424. In drainage paths 451 and 452, and exhaust path 453, open/close valves are provided, respectively.

Inner bath 421 is disposed within a case part 44 covering entire inner bath 421, and case part 44, as shown in FIG. 3, is disposed at the front side of second processing unit 133. Case part 44 is divided into an upper space 441 and a lower space 442 in the up-and-down direction by a partition plate 443. Upper space 441 receives cleaning bath 42 while lower space 442 discharges the liquid and gas discharged from drainage paths 451 and 452 and exhaust path 453, to the outside of cleaning/drying unit 4. In the drawing, the reference numerals 444 and 445, shown in upper space 441 and lower space 442, denote exhaust windows, and the reference numeral 446, shown in lower space 442, denotes a waste hole.

Drying chamber 41 includes a hood-type drying chamber main body 411 which has an opened bottom portion, and a U-shaped vertical section, and is made of quartz, polypropylene, or the like. Drying chamber 41 is disposed above cleaning bath 42 in such a manner that its opening can form a communication portion by facing the opening of cleaning bath 42. Also, at the bottom portion within drying chamber 41, an IPA vapor supply nozzle 412 for supplying a drying gas into drying chamber 41, and an exhaust pipe 414 for discharging a drying gas from drying chamber 41 are provided. IPA vapor supply nozzle 412 is provided with a plurality of upwardly opened supply holes.

Drying chamber main body 411 is configured to be movable upward and downward by a elevating means (not shown), and can move up and down between a lower position and an upper position. Herein, the lower position corresponds to a position where the opening of drying chamber main body 411 forms an airtight space by facing the opening of cleaning bath 42, as shown in FIG. 4, and the upper position corresponds to a position where drying chamber main body 411 is retreated toward the upper side than the lower position and transfers wafers W to/from carrying arm 136, as shown in FIG. 3. Also, wafer boat 413 is configured to be movable upward and downward by an elevating means (not shown) between the inside of drying chamber 41 and the inside of cleaning bath 42, and can move up and down a plurality of wafers W received by drying chamber 41 between a position indicated by a solid line and a position indicated by a dashed dotted line in FIG. 4.

Also, shutter 43 is provided at the middle-height position of drying chamber 41 and cleaning bath 42 provided with openings communicating with each other. Shutter 43 is to open/close the communication portion between drying chamber 41 and cleaning bath 42 by moving leftward and rightward (in a horizontal direction) from the perspective of FIG. 4.

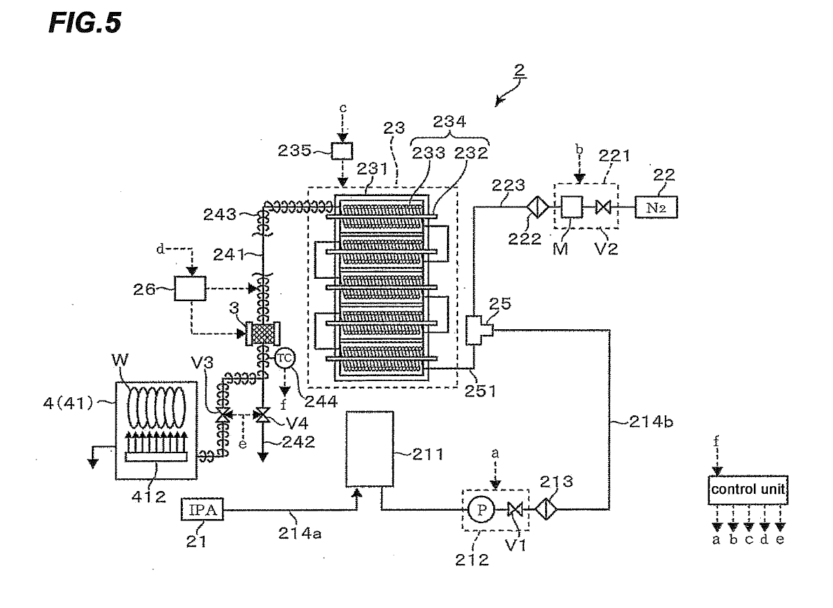

FIG. 5 shows a configuration of an IPA vapor generating unit 2 for supplying IPA vapor, as gas for drying wafers W, to the above described drying chamber 41. IPA vapor generating unit 2 includes a vapor generating unit 23 as a drying gas generating unit which generates IPA vapor from a mixed fluid of IPA and nitrogen supplied from an IPA supply system and a nitrogen supply system. IPA vapor generating unit 2 is provided, as shown in FIG. 1, at the backside of cleaning/drying unit 4.

As shown in FIG. 5, the IPA supply system includes an IPA tank 211, a supply control unit 212, and a filter 213, which are provided in this order on IPA supply paths 214a and 214b. IPA tank 211 is an intermediate tank which receives liquid-IPA supplied from an IPA supply source 21 at the outside and temporarily reservoirs it. Supply control unit 212 sends a predetermined amount of liquid-IPA from IPA tank 211 to the downstream side. Filter 213 removes particles contained in the liquid-IPA. Herein, supply control unit 212 is provided with a reciprocating pump P and an open/close valve V1.

Meanwhile, the nitrogen supply system includes a supply control unit 221 and a filter 222, which are provided in this order on a nitrogen supply path 223. Supply control unit 221 receives a predetermined amount of nitrogen supplied from a nitrogen supply source 22 at the outside. Filter 222 removes particles contained in nitrogen gas. Supply control unit 221 is provided with an open/close valve V2, and a mass flow controller M. IPA supply path 214b and nitrogen supply path 223 are connected to a common 2-fluid nozzle 25 which delivers a mixed fluid of IPA and nitrogen toward vapor generating unit 23 at the rear end via a mixed-fluid supply path 251. The mixed fluid of IPA and nitrogen is obtained by spraying liquid-IPA in a misty form in nitrogen gas atmosphere flowing through 2-fluid nozzle 25.

Vapor generating unit 23 performs a role of generating IPA vapor as gas for drying wafers W by heating a mixed fluid of misty IPA and nitrogen gas supplied from 2-fluid nozzle 25. Vapor generating unit 23 includes a main body chamber 231 which is divided into, for example, five, small chambers. Within each of the small chambers, a heating unit 234 for heating the mixed fluid of IPA and nitrogen gas is disposed. Each heating unit 234 includes a halogen lamp 232 and a spiral pipe 233. Halogen lamp 232 is formed into, for example, a straight rod shape. Spiral pipe 233 is spaced apart from halogen lamp 232 in the diameter direction around halogen lamp 232, and spirally extends in the longitudinal direction of halogen lamp 232.

Spiral pipe 233 includes a stainless pipe member which is painted, for example, a black color, so as to facilitate the absorption of the radiant heat from halogen lamp 232. Also, a spiral is formed between adjacent spiral pipes 233 in such a manner that the pipes adjacently disposed in the longitudinal direction can contact with each other, which prevents the radiant heat from halogen lamp 232 from easily being leaked to the outside from a gap between spiral pipes 233. Also, nitrogen gas is supplied from a nitrogen gas supply source (not shown) to each of the small chambers of main body chamber 231. In this heated atmosphere, the nitrogen gas prevents each of the small chambers from being invaded by IPA vapor or the like from the outside atmosphere.

Spiral pipes 233 of respective heating units 234 are serially connected so as to form one flow passage for passing a mixed fluid, in which one end at the upstream side is connected to mixed-fluid supply path 251, and the other end at the downstream side is connected to an IPA vapor supply path 241 for supplying IPA vapor to drying chamber 41. From among 5 serially disposed heating units 234, for example, 2 heating units at the upstream side perform a role of evaporating misty IPA from the mixed fluid, and the rest, for example, 3 heating units at the downstream side perform a role of preventing the IPA from being condensed. More specifically, the 3 heating units at the downstream side heat a mixed fluid of IPA vapor obtained by evaporating IPA and nitrogen gas (hereinafter simply referred to as IPA vapor) up to a higher temperature range (e.g. 150˜200° C.) than a dew point temperature of IPA vapor, for example, up to 190° C., and places the IPA vapor in a over-heated state, thereby preventing the IPA from being condensed.

Herein, a device for generating IPA vapor is not limited to the above described vapor generating unit 23 provided with halogen lamp 232 and spiral pipe 233. For example, a mixed gas of IPA and nitrogen gas, which is obtained by bubbling nitrogen gas in liquid-IPA, may be heated to generate IPA vapor.

In each heating unit 234, a temperature detector (not shown) is provided, which can detect the outlet temperature of a mixed fluid flowing through each spiral pipe 233. The results of detected temperatures are output to a control unit 5 which will be described later, and are fed back, as a control amount of a supplied power, to a power supply unit 235 supplying power to each halogen lamp 232, thereby carrying out controlling the temperature of each heating unit 234.

The IPA vapor generated from vapor generating unit 23 is supplied to IPA vapor supply nozzle 412 provided within drying chamber 41 of the above described cleaning/drying unit 4 via IPA vapor supply path 241. A filter unit 3 is provided in IPA vapor supply path 241 so as to remove particles or the like contained in the IPA vapor. Then, the IPA vapor is supplied as a drying gas to drying chamber 41.

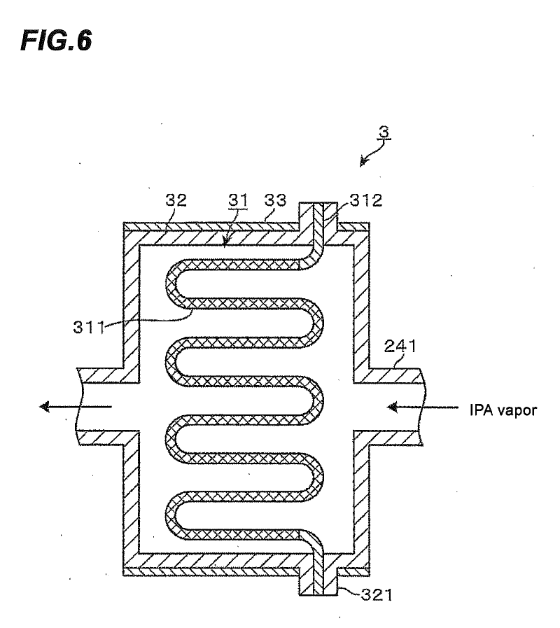

As shown in FIG. 6, filter unit 3 includes a cartridge-type metallic filter 31 (filter medium) disposed and fixed within a filter medium receiving portion, for example, a cylindrical filter sleeve 32. Metallic filter 31 includes a flange seat portion 312 and a cylindrical filter medium portion 311. Flange seat portion 312 includes a metallic member, for example, in a circular annular shape. Filter medium portion 311 is made of a filtration material, for example, a porous sintered metal, and has a closed end. Flange seat portion 312 is fixed in a flange 321 at filter sleeve 32 side. When flange seat portion 312 is at the base end side, plural lines of filter medium portion 311 are extendingly fixed to flange seat portion 312 from the base end toward the leading end. The IPA vapor flowing through the inside of filter unit 3 passes through the filtration material of metallic filter 31 from the base end side toward the leading end side, by which particles are filtered off.

Also, as described in the background, it can be known that in metallic filter 31, a trace amount of impurities, such as a high-boiling point organic material contained in IPA vapor, are adsorbed and trapped within sintered metal's pores constituting, for example, filter medium of metallic filter 31.

On the outer surfaces of IPA vapor supply path 241 and filter sleeve 32, tape heaters 243 and 33 are wound, which maintain the temperature of IPA vapor flowing through the inside of IPA vapor supply path 241 and filter sleeve 32 at the same temperature as the outlet temperature of vapor generating unit 23. For example, a temperature detector 244 including a thermocouple or the like is provided in IPA vapor supply path 241 at the outlet side of filter unit 3. Thus, the results of detected temperatures of IPA vapor are output to control unit 5 which will be described later, and are fed back, as a control amount of a supplied power, to a power supply unit 26 supplying power to each of tape heaters 243 and 33, thereby controlling the temperature.

Also, an open/close valve V3 is provided in IPA vapor supply path 241 at the downstream side of filter unit 3, and an exhaust path 242 with an open/close valve V4 is connected to a position between filter unit 3 and open/close valve V3. The opening/closing of these open/close valves V3 and V4 can switch the flowing direction of gas passed from filter unit 3 between drying chamber 41 side and exhaust path 242 side. Exhaust path 242 is connected to, for example, a harm-removing facility of a plant.

Wafer cleaning apparatus 1 having the above described configuration is connected to control unit 5 as shown in FIGS. 1 and 5. Control unit 5 includes a computer provided with, for example, a CPU and a memory unit (not shown). In the memory unit, a program having a group of control steps (commands) related to operations of wafer cleaning apparatus 1 is recorded. The operations include loading of FOUP 8 into loading/unloading device 11, taking-out of wafers W, various kinds of liquid processings on wafers W, storing of wafers W into FOUP 8, and unloading of FOUP 8. This program is stored in a recording medium, such as a hard disk, a compact disk, a magneto-optical disk, a memory card, and the recording medium is provided in a computer.

Also, in the memory unit of control unit 5, beside the above described control program related to the operations for performing a cleaning process on wafers W, a program for executing the purging operation of a high-boiling point organic material, as accretion, attached on metallic filter 31 within filter unit 3 is recorded. In purging the high-boiling point organic material, gas flowing through filter unit 3 is switched from a drying gas for wafers W to a purging gas for metallic filter 31, and the temperature of the purging gas is adjusted to be higher than the temperature of the drying gas. Operations of respective components, before/following the switching of gas, will be described later in detail.

Hereinafter, the operation of wafer cleaning apparatus 1 provided with the above described configuration will be described. For example, when FOUP 8 storing 25 wafers W is carried by a carrying robot or the like, and disposed on disposition table 112 of any one of load port 111 at the right side, open/close door 118 is opened so that disposition table 112 can be slid to allow FOUP 8 to be loaded into loading/unloading device 11. First lifter 114a raises FOUP 8 from disposition table 112 and moves FOUP 8 to a position facing open/close door 127 of interface device 12 side as shown in FIG. 2.

Open/close door 127 removes the cover of FOUP 8, and wafer taking-out arm 121 advances into FOUP 8 to take out wafers W. Then, wafers W are loaded into first interface chamber 120a. FOUP 8 in an empty state after unloading of wafers W is covered with a cover, carried to keeping area 116 by first lifter 114a, and is kept until the completion of the processing on wafers W.

Notch aligner 123 positions wafers W loaded into first interface chamber 120a, and first posture altering part 124 adjusts the intervals among wafers W and alter the posture of wafers W. Then, wafers W are transferred to carrying arm 136 advanced into interface device 12. Wafers W supported by carrying arm 136 are transferred to wafer boat 132 of first processing unit 131, and are immersed in an APM liquid reservoired in a processing bath so as to remove particles or organic pollutants. Then, wafers W are cleaned by a cleaning liquid, such as deionized water.

After the first cleaning in first processing unit 131, wafers W are transferred to carrying arm 136 again, transferred to wafer boat 134 of second processing unit 133, and immersed in a chemical liquid, such as an HPM liquid so as to remove metallic pollutants. Then, wafers W are cleaned by deionized water. After the second cleaning, wafers W are transferred to carrying arm 136 again, and carried to cleaning/drying unit 4.

When wafers W which have been subjected to the second cleaning are carried back by carrying arm 136, cleaning/drying unit 4 is in a stand-by mode in a state where it raised drying chamber main body 411 and placed shutter 43 in a closed state. Then, wafers W are transferred from carrying arm 136 to wafer boat 413 of cleaning/drying unit 4. Next, when carrying arm 136 is retreated, wafer boat 413 is lowered by opening of shutter 43, wafers W are loaded into cleaning bath 42, and drying chamber main body 411 is lowered to form an airtight space by cleaning bath 42 and drying chamber 41.

Then, a chemical liquid, such as hydrofluoric acid, is supplied from liquid supply nozzle 423 to wafers so as to chemically clean wafers W, and the liquid supplied from liquid supply nozzle 423 is substituted with deionized water so as to perform a cleaning process. After the cleaning of wafers W, wafer boat 413 is raised so as to carry wafers W into wafer boat 413. Then, the inside of drying chamber 41 is blocked off from cleaning bath 42 and outside air by closing of shutter 43, and IPA vapor, as a drying gas, is supplied from IPA vapor supply nozzle 412 into drying chamber 41.

IPA vapor supplied into drying chamber 41, as indicated by arrows shown in FIG. 4, flows upward along the inner surfaces of both lateral walls of drying chamber main body 411, and at the summit of drying chamber main body 411, the flowing direction of the IPA vapor is changed from upward to downward so that the IPA vapor is discharged from exhaust pipe 414 to the outside. This makes it possible to uniformly contact a drying gas with wafers W and to uniformly dry the surfaces of wafers W.

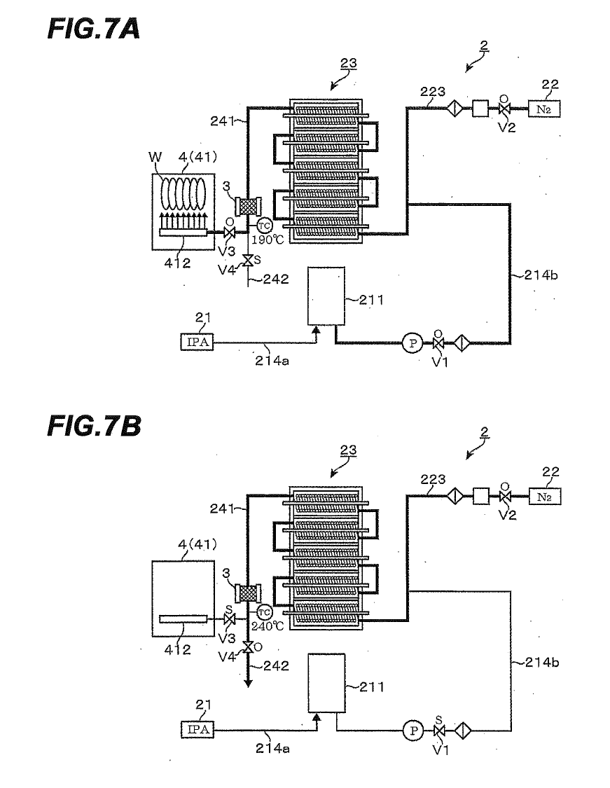

Herein, in IPA vapor generating unit 2 for supplying IPA vapor, in a state where open/close valve V1 in IPA supply path 214b, open/close valve V2 in nitrogen supply path 223 and open/close valve V3 in IPA vapor supply path 241 are opened as shown in FIG. 7A (indicated by “O”, hereinafter the same), a mixed fluid of misty IPA and nitrogen gas is supplied to vapor generating unit 23, vapor generating unit 23 generates IPA vapor by evaporating and over-heating IPA, metallic filter 31 within filter unit 3 removes particles contained in IPA vapor, and then the IPA vapor is supplied to IPA vapor supply nozzle 412 of drying chamber 41. The temperatures of IPA vapor at outlets of vapor generating unit 23 and filter unit 3 are maintained at, for example, 190° C., by the adjustment of power supplied to spiral pipe 233 or tape heaters 243 and 33. Herein, since open/close valve V4 of exhaust path 242 is in a “closed” state (indicated by “S” in FIG. 7A, hereinafter the same), IPA vapor does not flow toward exhaust path 242 side. Also, in FIGS. 7A and 7B, 2-fluid nozzle 25 or tape heater 243 is omitted.

As described above, since IPA vapor is pre-heated up to 190° C. before flowing through metallic filter 31, metallic filter 31 is heated by the IPA vapor up to almost the same temperature as that of the IPA vapor (which corresponds to a first temperature of the present disclosure). In other words, IPA vapor generating unit 2's halogen lamp 232 adjusting the temperature of IPA vapor, or tape heater 243 covering IPA vapor supply path 241, performs a role as a filtration material heating part for heating metallic filter 31 up to the first temperature by IPA vapor. At the same time, the heat supplied from tape heater 33 provided in filter sleeve 32 is also supplied to metallic filter 31 via IPA vapor flowing through the inside of filter sleeve 32. Thus, it can be determined that metallic filter 31 is heated up to the first temperature by tape heater 33. In this point of view, tape heater 33 provided in filter unit 3 also performs a role as a filtration material heating part for heating metallic filter 31 up to the first temperature.

Then, during passing of IPA vapor through metallic filter 31, when the IPA vapor contains impurities such as a high-boiling point organic material, the impurities are trapped within the pores of metallic filter 31 and accumulated in metallic filter 31. Also, when an organic material or the like, as accretion, is attached on a pipe system 212, 223, 233, 241, and 251 at the upstream side of filter unit 3, the accretion flows toward the downstream side by IPA vapor and is trapped and accumulated in metallic filter 31.

Now, referring back to description on processing of wafers W, after the drying process within drying chamber 41, the atmosphere within drying chamber 41 is substituted by nitrogen gas, and drying chamber main body 411 is raised so as to transfer wafers W from wafer boat 413 to carrying arm 136. Then, wafers W are transferred to transfer arm 126 within second interface chamber 120b, and second posture altering part 125 altering a vertical posture of wafers W into a horizontal posture. In parallel with these operations, first lifter 114b provided at the left side from the perspective of the front area carries FOUP 8 kept in keeping area 116 to a position facing open/close door 127 of second interface chamber 120b side, and places FOUP 8 in a stand-by mode in a state where the cover of FOUP 8 is removed by open/close door 127.

Wafer storing arm 122 loads wafers W from second posture altering part 125 into FOUP 8, closes the cover after storing of wafers W, and carries FOUP 8 by first lifter 114b. Herein, within loading/unloading device 11, disposition table 112 of load port 111 at the left side from the perspective of the front area is slid and is in a stand-by mode, and first lifter 114b disposes FOUP 8 on disposition table 112. Then, open/close door 118 is opened, and disposition table 112 is slid to position FOUP 8 on load port 111. Herein, FOUP 8 storing wafers W whose process has been completed is carried to the next process by a carrying robot. In wafer cleaning apparatus 1 according to the present embodiment, the above described operations are sequentially executed. For example, a several hundreds of wafers W may be processed per hour.

In the above described operations, a high-boiling point organic material or the like trapped by metallic filter 31 of filter unit 3 is placed in a saturation state in a short time by accumulation, and is splintered off toward drying chamber 41 at downstream side. Thus, it becomes a pollution source of wafers W. Therefore, wafer cleaning apparatus 1 according to the present embodiment can carry out a recycling process of metallic filter 31. In the recycling process, at a predetermined timing, the gas flowing through filter unit 3 is converted from IPA vapor as a drying gas to a purging gas, metallic filter 31 as filter medium is heated so as to evaporate a high-boiling point organic material attached on metallic filter 31 to remove it from metallic filter 31, and the high-boiling point organic material, together with the purging gas, is discharged to the outside of the system of IPA vapor generating unit 2.

In one example of this recycling process according to the present embodiment, as shown in FIG. 7B, the flow passage is switched by “opening” of open/close valve V2 of nitrogen supply path 223 and open/close valve V4 of exhaust path 242, while “closing” of open/close valve V1 of IPA supply path 214b and open/close valve V3 of IPA vapor supply path 241. Then, nitrogen gas supplied from nitrogen supply source 22 is heated in vapor generating unit 23 in a state where it contains no IPA. The nitrogen gas as a purging gas is passed through filter unit 3, and is discharged to exhaust path 242. Next, the amount of heat generated by halogen lamp 232 of vapor generating unit 23, or tape heaters 243 and 33 provided in IPA vapor supply path 241 and filter unit 3 is increased, thereby heating the purging gas up to a temperature higher than that of the drying gas, for example, up to 240° C.

In this case, IPA vapor is pre-heated up to 240° C. before flowing through metallic filter 31, and thereby metallic filter 31 is heated by the IPA vapor, up to almost the same temperature as that of the IPA vapor (which corresponds to a second temperature of the present disclosure). At the same time, as described above, it can be determined that metallic filter 31 is heated up to the second temperature by tape heater 33 provided in filter unit 3.

Also, through the heating of metallic filter 31 up to the second temperature (e.g., 240° C.) higher than the first temperature (e.g., 190° C.) of a drying process, a high-boiling point organic material is evaporated and is, together with the purging gas, discharged from exhaust path 242 to the outside of the apparatus. From the above described operations, it can be known that IPA vapor generating unit 2 according to the present embodiment performs as both a purging gas supply unit and a temperature adjusting unit.

Herein, since IPA vapor supply path 241 connected to drying chamber 41 is closed by open/close valve V3, the purging gas containing the high-boiling point organic material does not flow toward drying chamber 41 performing a drying process. Thus, it is possible to prevent wafers W from being polluted by this purging operation. Accordingly, it is preferable that exhaust path 242 is branched from IPA vapor supply path 241 at the position as close as possible to the outlet of filter unit 3.

Wafer cleaning apparatus 1 according to the present embodiment can achieve the following effects. During a drying process on wafers W, metallic filter 31 for removing particles contained in IPA vapor used for the drying process is heated up to a first temperature higher than a dew point temperature of IPA vapor, and during a recycling process of metallic filter 31, metallic filter 31 is heated up to a second temperature higher than the first temperature. This makes it possible to evaporate and remove accretion, such as a high-boiling point organic material, attached on metallic filter 31 in a state where metallic filter 31 is disposed in IPA vapor supply path 241. As a result, there is no need to dismantle or re-assemble a pipe system 212, 223, 233, 241, and 251 of a drying gas to replace metallic filter 31 with a new one, and it is possible to improve the working ratio of wafer cleaning apparatus 1 by reducing the stop period of it.

In the above described embodiment, in heating metallic filter 31 by switching the temperature between a first temperature for a drying process and a second temperature for a recycling process, two kinds of methods are used. The methods for heating metallic filter 31 include one method for using IPA vapor pre-heated in IPA vapor generating unit 2 or heat of a purging gas, and the other method for using tape heater 33 provided in filter unit 3. However, only one of the two methods may be used to heat metallic filter 31. For example, filter unit 3 may be covered with, for example, a heat insulator, instead of tape heater 33, and the temperature of metallic filter 3 may be adjusted by the amount of heat supplied from IPA vapor generating unit 2 or tape heater 243 covering IPA vapor supply path 241. Also, in opposite manner to this, various kinds of gases may be flown into filter unit 3 at a temperature lower than the above described first and second temperatures, and the temperature of metallic filter 3 may be adjusted by the amount of heat generated by tape heater 33 of filter unit 3 up to the above mentioned first and second temperatures.

Also, the method for heating metallic filter 31 is not limited to the above described two kinds of methods. For example, a power may be applied to metallic filter 31 itself so that metallic filter 31 can be heated by its resistance heat and converted into the first temperature and the second temperature. Also, a purging gas is not limited to nitrogen gas. For example, an inert gas, such as argon gas, may be used.

The accretion, which can be removed from metallic filter 31 by raising the temperature of metallic filter 31 from the first temperature to the second temperature, is not limited to the above mentioned high-boiling point organic material. For example, the present disclosure may be applied to the case where an acidic or alkaline material is attached on metallic filter 31 by back-flowing of the atmosphere from processing unit 13, and this accretion is evaporated and removed at a second temperature higher than a first temperature for a drying process.

Meanwhile, in the example according to the above described embodiment, as a drying gas, a mixed gas of vapor of IPA (an organic solvent) and nitrogen gas (an inert gas) is used. However, a gas that may be used as the drying gas is not limited to the example. For example, a mixed gas of another organic solvent (such as acetone) and an inert gas may be employed. Further, an inert gas, such as nitrogen gas, may be used alone as a drying gas. In this case, when the drying gas contains impurities, accretion may be attached on metallic filter 31.

Also, as filter medium, disposed within IPA vapor generating unit 2, for a recycling process by an increase in the temperature from a first temperature to a second temperature, for example, a ceramic filter as well as above described metallic filter 31 may be used without limitation. In this case, accretion (such as a high-boiling point organic material) attached to the ceramic filter may be evaporated by heating the filter from a first temperature to a second temperature, and discharged together with a purging gas.

Also, the purging of metallic filter 31 may be carried out with an interval of several hours or several days, or may be carried out whenever a predetermined number of times of processing are performed by cleaning/drying unit 4, at the timing where wafers W are not processed by wafer cleaning apparatus 1. Also, even at the timing where wafers W are processed in wafer cleaning apparatus 1, wafer cleaning apparatus 1 may be driven in such a manner that the supply of a drying gas and the purging are switched to each other. For example, at the timing where a drying process is performed on wafers W and IPA vapor is supplied to drying chamber 41, wafer cleaning apparatus 1 may be placed in the state shown in FIG. 7A, and at the timing where IPA vapor is not supplied to drying chamber 41, it may be placed in the state shown in FIG. 7B.

Besides, in the present embodiment, a gas supply system and a filtration material heating part for adjusting the temperature of the gas are commonly used by a purging gas and a drying gas. However, needless to say, a pipe dedicated for the supply of a purge gas, provided with a temperature controller, may be connected to IPA vapor supply path 241 at the upstream of filter unit 3 so as to supply the purge gas from a different system from that of a drying gas.

### EXAMPLE

### Experiment

From an IPA vapor generating unit of an actually driven wafer cleaning apparatus 1, metallic filter 31 which has been completely used, and from an experimental IPA vapor generating unit, metallic filter 31 through which IPA vapor has been passed were collected, respectively. Then, materials attached on each of metallic filters 31 were analyzed. In this analysis, GC-MS (commercially available from Gas Chromatography-Mass Spectrometer; Agilent Technology, 6890-5973N) according to a dynamic headspace method was used.

### A. Experimental Conditions

### Reference Example

From a new metallic filter 31 through which IPA vapor has not been passed, the components attached on metallic filter 31 were analyzed.

### Example 1

In an actually driven wafer cleaning apparatus, the components attached on metallic filter 31 (within an IPA vapor generating unit) which has been completely used were analyzed.

### Example 2

After IPA vapor is passed through the inside of the experimental IPA vapor generating unit for about half a year, the components attached on metallic filter 31 were analyzed.

### B. Result of Experiment

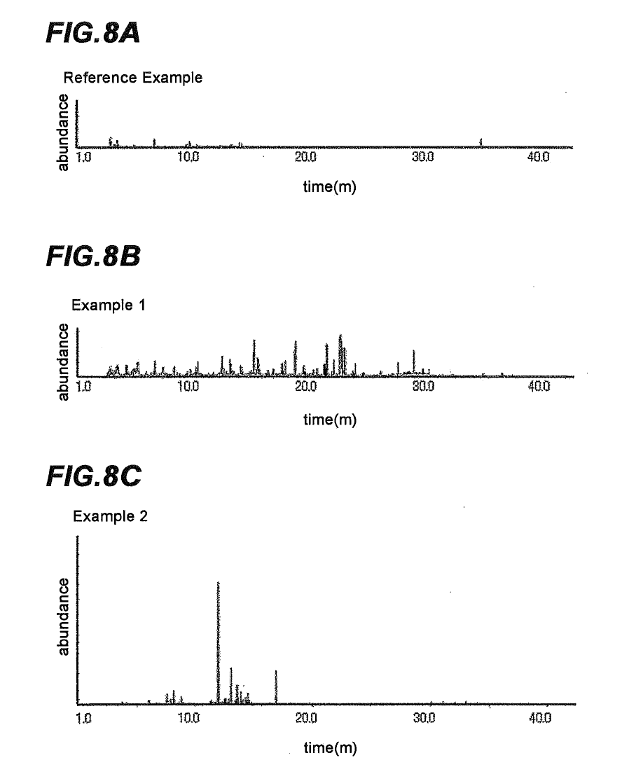

The results of Reference Example, Example 1, and Example 2 are shown in FIGS. 8A, 8B, and 8C, respectively. In each drawing, the horizontal axis indicates a retention time of gas chromatography, and the vertical axis indicates abundance of a detected component in each retention time.

From the result of Reference Example, shown in FIG. 8A, it can be seen that a peak with detection intensity is hardly observed in a retention time range of up to 40 minutes, and an organic material is not attached on metallic filter 31. Meanwhile, according to the results of Examples 1 and 2, shown in FIGS. 8B and 8C, in Example 1, multiple peaks are observed in a wide retention time range of several minutes to 30 minutes, and in Example 2, multiple peaks are observed in a retention time range of about 10 to 20 minutes. Also, according to the result obtained by mass spectrometry, the peaks indicate organic materials. From this finding, it can be known that when IPA is passed through, many kinds of organic materials are attached on metallic filter 31. Besides, in a retention time range of 10 or more minutes, where a boiling point is generally expected to be high, various kinds of organic materials are detected from metallic filter 31. Also, on metallic filter 31, an organic material having a relatively high boiling point is also attached. Accordingly, the accretion attached on metallic filter 31 within IPA vapor generating unit 2 is evaporated by being heated up to a second temperature higher than a first temperature of passing-through of IPA vapor, and is removed from metallic filter 31, thereby recycling filter 31.

From the foregoing, it will be appreciated that various embodiments of the present disclosure have been described herein for purposes of illustration, and that various modifications may be made without departing from the scope and spirit of the present disclosure. Accordingly, the various embodiments disclosed herein are not intended to be limiting, with the true scope and spirit being indicated by the following claims.

What is claimed is:

1. A substrate processing device to perform a drying process on a substrate by a drying gas, the substrate processing device comprising:
a drying gas generating unit to generate the drying gas by heating a fluid, the drying gas generating unit having a temperature adjustment function;
a filtration material to remove particles contained in the drying gas generated by the drying gas generating unit;
a filtration material heating part to heat the filtration material;
a processing unit to perform the drying process by using the drying gas having passed through the filtration material; and
a control unit to control the filtration material heating part in such a manner that the filtration material heating part heats the filtration material up to a first temperature during the drying process in order to maintain the drying gas supplied to the processing unit at a temperature higher than a dew point temperature of the drying gas, and heats the filtration material up to a second temperature higher than the first temperature during a recycling process of the filtration material in order to evaporate and remove accretion attached on the filtration material.

2. The substrate processing device as claimed in claim 1, wherein the filtration material is made of a metallic material or a ceramic material.

3. The substrate processing device as claimed in claim 1, wherein the filtration material is received in a filtration material receiving portion, the filtration material heating part comprises a heater to heat the filtration material receiving portion, and the control unit controls an amount of heat generated by the heater during the recycling process of the filtration material to be higher than an amount of heat generated by the heater during the drying process.

4. The substrate processing device as claimed in claim 1, further comprising a purging gas supply unit to supply a purging gas to the filtration material in order to discharge an evaporated substance of the accretion attached on the filtration material during the recycling process of the filtration material.

5. The substrate processing device as claimed in claim 4, wherein the purging gas supply unit has a temperature adjustment function in order to perform as the filtration material heating part to heat the filtration material by the purging gas.

6. The substrate processing device as claimed in claim 5, wherein the temperature adjustment function of the purging gas supply unit comprises the temperature adjustment function of the drying gas generating unit.

7. The substrate processing device as claimed in claim 4, further comprising an exhaust path formed between the filtration material and the processing unit, and a flow path switching part to switch a flow path of a gas having passed through the filtration material between a processing unit side and an exhaust path side, wherein the control unit switches a flow path of the purging gas having passed through the filtration material toward the exhaust path side during the recycling process of the filtration material.

8. The substrate processing device as claimed in claim 1, wherein the drying gas is a mixed gas of vapor of an organic solvent and inert gas.

9. The substrate processing device as claimed in claim 8, wherein the organic solvent is isopropyl alcohol.

10. A recycling method of a filtration material provided in a substrate processing device, the substrate processing device performing a drying process on a substrate by a drying gas, the recycling method comprising:
obtaining the drying gas by heating a fluid containing an organic material while adjusting a temperature;
removing particles contained in the obtained drying gas by a filtration material;
performing the drying process by supplying the drying gas having passed through the filtration material to a processing unit of the substrate;
heating the filtration material up to a first temperature during the drying process in order to maintain the drying gas supplied to the processing unit at a temperature higher than a dew point temperature of the drying gas; and
heating the filtration material up to a second temperature higher than the first temperature during a recycling process of the filtration material in order to evaporate accretion attached on the filtration material.

11. The recycling method as claimed in claim 10, wherein the filtration material is received in a filtration material receiving portion, the filtration material receiving portion comprises a heater to heat the filtration material receiving portion, and in the heating of the filtration material up to the second temperature, an amount of heat generated by the heater during the recycling process of the filtration material is controlled to be higher than an amount of heat generated by the heater during the drying process.

12. The recycling method as claimed in claim 10, wherein the substrate processing device comprises a purging gas supply unit to supply a purging gas to the filtration material in order to discharge an evaporated substance of the accretion attached on the filtration material during the recycling process of the filtration material, and heats the filtration material by the purging gas supplied from a purging gas supply unit in the heating of the filtration material up to the second temperature, the purging gas supply unit having a temperature adjustment function of the purging gas.

13. A recording medium recording a computer program used for a substrate processing device, the substrate processing device performing a drying process on a substrate by a drying gas, wherein the computer program comprises a group of program codes to execute the recycling method of the filtration material, as claimed in claim 10.
